(19) United States
(12) Patent Application Publication
(10) Pub. No.: US 2018/0276033 A1
(43) Pub. Date: Sep. 27, 2018

(54) INFORMATION PROCESSING APPARATUS, CONTROL METHOD FOR INFORMATION PROCESSING APPARATUS, AND APPLICATION MANAGEMENT METHOD

(71) Applicant: CANON KABUSHIKI KAISHA, Tokyo (JP)

(72) Inventor: Takeshi Tarumi, Kawasaki-shi (JP)

(21) Appl. No.: 15/927,316

(22) Filed: Mar. 21, 2018

(30) Foreign Application Priority Data
Mar. 24, 2017 (JP) 2017-058461

(51) Int. Cl. G06F 9/48; G06F 9/50; G06F 9/451

(52) U.S. Cl. CPC G06F 9/485; G06F 9/451; G06F 9/5016; G06F 9/505

(57) ABSTRACT

An information processing apparatus manages a plurality of operating applications. The information processing apparatus determines whether an activated user interface (UI) application is able to receive a clear execution notification from a system and executes reactivation processing of the UI application to release resources at the end of the UI application.

### BACKGROUND OF THE INVENTION

### Field of the Invention

One aspect of the disclosed embodiments relates to management of embedded applications in information processing.

Description of the Related Art

Some information apparatuses are already embedded with a plurality of applications. Generally, in an execution environment of the embedded applications of such information apparatuses, a total amount of resources usable by the embedded applications is limited. This is because the resources usable by the embedded applications are dependent on the amount of resources of the information apparatus itself, and the resources such as a memory of the information apparatus is consumed along with activation of the embedded applications in the execution environment thereof.

For example, in a user interface (UI) application described in Java (registered trademark), an object is referred when a UI is to be displayed, so that a memory is consumed. A memory area used for referring to the object is retrieved by a function such as a garbage collection when the UI application terminates the reference of the object. However, in a case where the reference of the object is not terminated, a memory area occupied by the UI application is continuously held without being released.

In recent years, in many cases, function enhancement of the information apparatus embedded with an application has been accompanied by function enhancement of the application, and thus the application has been expanded continuously. If the application is expanded continuously, a memory area that is not released but occupied by the application may also be increased continuously.

There may be a case where a plurality of applications is activated in the execution environment of the embedded application having a limited amount of usable resources. If a plurality of applications is activated in such an environment, a method for releasing the resources such as a memory area by ending unnecessary applications through an application management unit may be necessary for managing activation of the applications.

For example, although a plurality of applications may be activated in a smartphone, it is often the case that a user is provided with means for ending the application. This is possible because a user who operates the smartphone can be limited to a particular individual.

On the other hand, in the case of an information processing apparatus such as an image forming apparatus accessed by a plurality of users, if means which enables a user to freely end the application is provided, there arises a problem that one user can end the application regardless of a usage status of another user.

Further, with regard to a smartphone, there is provided a technique for realizing a stable operation (see Japanese Patent No. 5729767). In the technique, operation of an application is monitored, and the application is reactivated when abnormality arises in the operation thereof.

However, with regard to the embedded UI application used by a plurality of users, means for ending or reactivating the UI application has not been provided. Accordingly, there has been a problem that the reference of the object cannot be terminated and thus the resources are occupied continuously.

### SUMMARY OF THE INVENTION

One aspect of the disclosed embodiments is directed to a method for reducing consumption of resources in an information processing apparatus without deteriorating usability of the information processing apparatus.

According to an aspect of the embodiments, an information processing apparatus which manages a plurality of operating applications includes a first determination unit. The first determination unit is configured to determine whether the application has made a declaration of rejecting clear execution in a case where use of the application is ended. In a case where the first determination unit determines that the application has not made the declaration of rejecting clear execution, the information processing apparatus executes reactivation processing of the application.

Further features of the disclosure will become apparent from the following description of exemplary embodiments with reference to the attached drawings.

### BRIEF DESCRIPTION OF THE DRAWINGS

FIG. 1 is a diagram illustrating a general configuration of one embodiment.

FIG. 2 is a block diagram illustrating a hardware configuration of an image forming apparatus of one embodiment.

FIG. 3 is a block diagram illustrating a configuration of an execution environment of an application according to an exemplary embodiment.

FIGS. 4A and 4B are diagrams illustrating a file configuration of the application according to an exemplary embodiment.

FIG. 5 is a flowchart illustrating a processing flow according to a first exemplary embodiment.

FIG. 6 is a diagram illustrating transition of a state of an application according to an exemplary embodiment.

FIG. 7 is a flowchart illustrating a processing flow according to a second exemplary embodiment.

FIGS. 8A and 8B are diagrams for supplementing descriptions of the second exemplary embodiment.

FIG. 9 is a flowchart illustrating a processing flow according to a third exemplary embodiment.

FIG. 10 is a flowchart illustrating a processing flow according to a fourth exemplary embodiment.

### DESCRIPTION OF THE EMBODIMENTS

Hereinafter, an exemplary embodiment will be described with reference to the appended drawings.

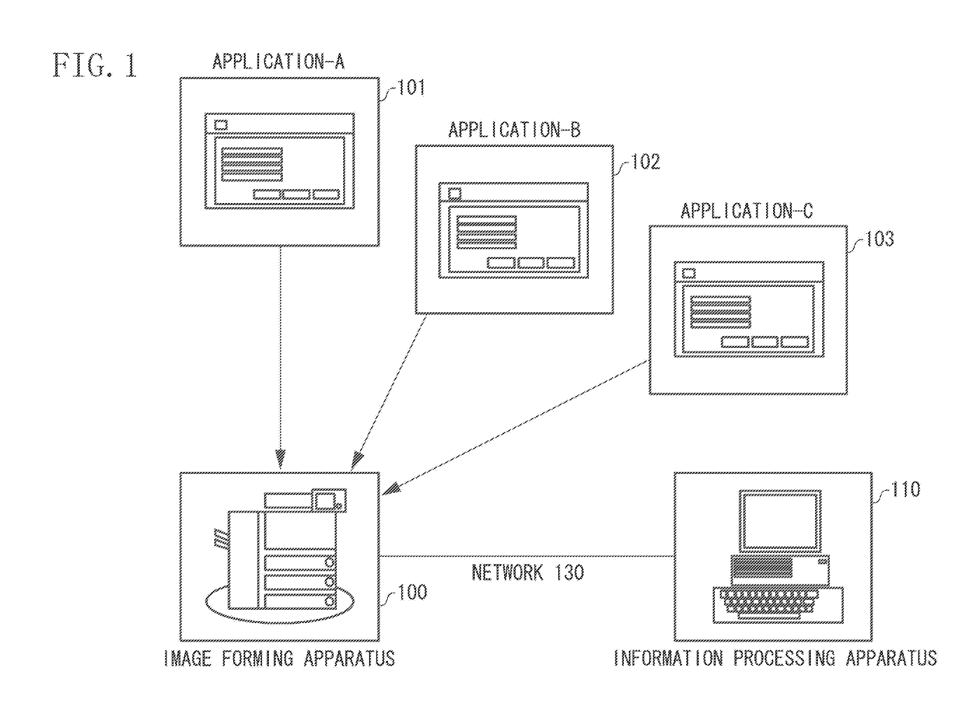

FIG. 1 is a diagram illustrating a general configuration of an exemplary embodiment.

An image forming apparatus 100 is one example of an information processing apparatus. The image forming apparatus 100 is communicably connected to an information processing apparatus 110 via a network 130.

An application-A 101, an application-B 102, an application-C 103 are applications respectively operating on the image forming apparatus 100. One or a plurality of applications can be operated on the image forming apparatus 100. In FIG. 1, three applications are operated on the image forming apparatus 100. A user or an administrator is provided with a basic function of the image forming apparatus 100, the application-A 101, the application-B 102, the application-C 103, and a method of managing the image forming apparatus 100 and applications operating thereon. Further, the user can operate the image forming apparatus 100 directly or indirectly from the information processing apparatus 110 via the network 130.

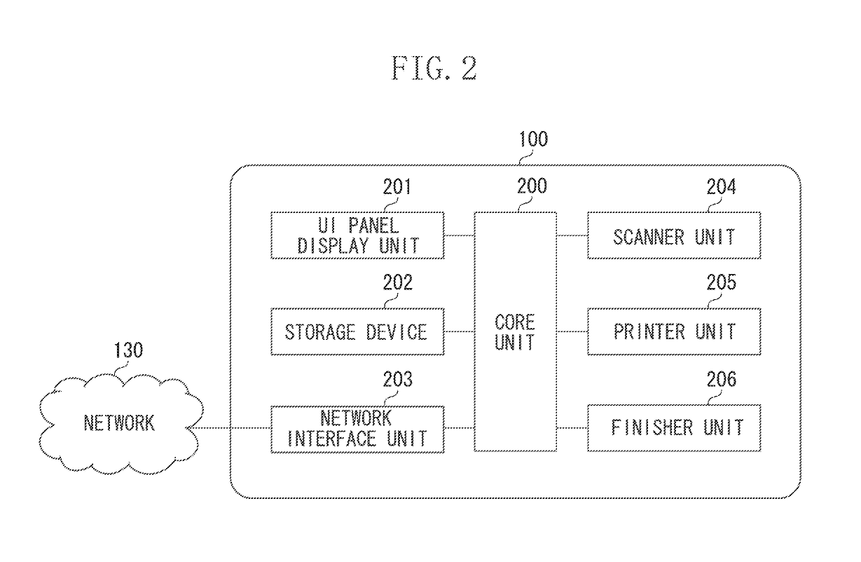

FIG. 2 is a block diagram illustrating a hardware configuration of the image forming apparatus 100.

The image forming apparatus 100 includes a core unit 200, a user interface (UI) panel display unit 201, a storage device 202, a network interface unit 203, a scanner unit 204, a printer unit 205, and a finisher unit 206.

A central processing unit (CPU) and a random access memory (RAM), both of which are not illustrated, are mounted on the core unit 200. The CPU loads programs such as an operating system (OS), an application execution platform, and applications which are stored in the storage device 202 and mounted on the image forming apparatus 100 onto the RAM, and executes the programs by reading the programs from the RAM. The UI panel display unit 201 displays the content processed by the core unit 200 and receives an input from a user through an input unit provided thereon. The storage device 202 stores a program or a data file processed by the core unit 200.

The image forming apparatus 100 is connected to the network 130 via the network interface unit 203. The scanner unit 204 having a scanner function, the printer unit 205 having a printing function, and the finisher unit 206 having a finishing function are connected to the core unit 200, and operations thereof are controlled by the core unit 200.

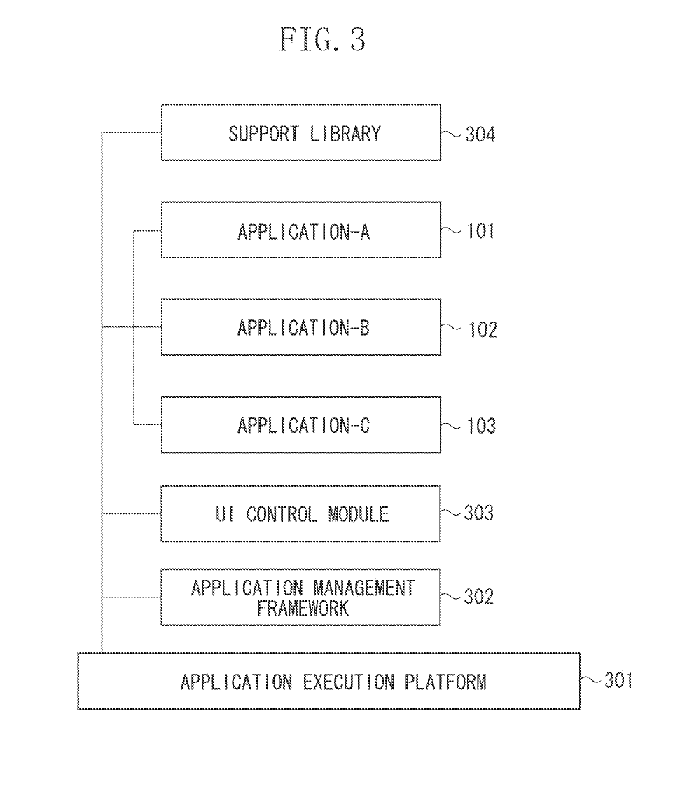

FIG. 3 is a block diagram illustrating an execution environment for executing the application-A 101, the application-B 102, and the application-C 103 in the image forming apparatus 100 of the present exemplary embodiment.

An application execution platform 301 is a platform for operating applications.

Processing of installing, uninstalling, or stopping the application-A 101, the application-B 102, or the application-C 103 is managed by an application management framework 302 operating on the application execution platform 301.

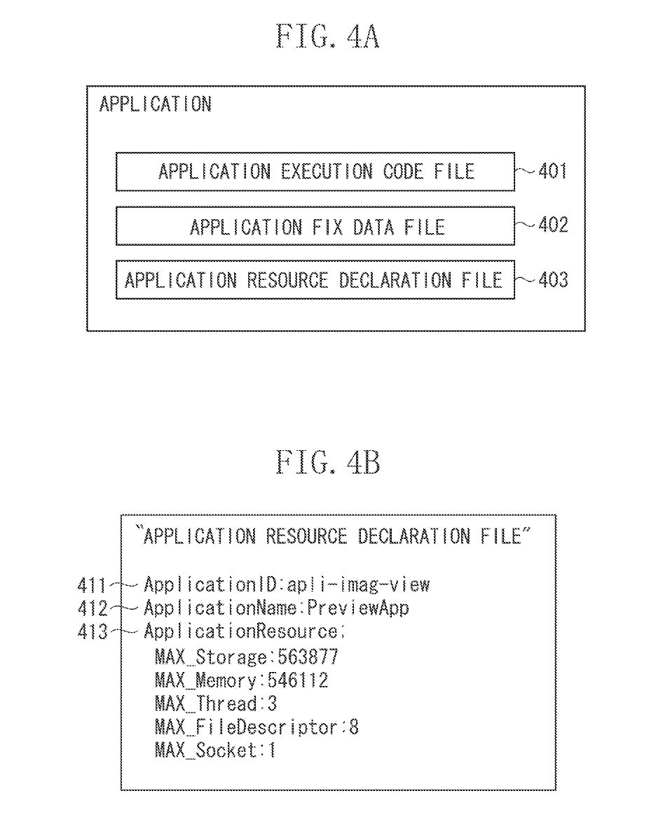

When installation processing of the application-A 101, the application-B 102, or the application-C 103 is to be executed, the application management framework 302 refers to an application resource declaration file 403 (see FIG. 4A) of the application-A 101, the application-B 102, or the application-C 103. Then, the application management framework 302 determines whether an upper limit value of the resources declared in the file falls within an amount of a free space of the resources in the current execution environment of applications. Based on the determination result, the application management framework 302 executes install processing of the application if the upper limit value falls within the amount of the free space. If the upper limit value does not fall within the amount of the free space, the application management framework 302 executes processing of returning an error.

The UI control module 303 executes control when the application-A 101, the application-B 102, or the application-C 103 forms a UI screen, and manages shifting of the screen from a basic screen to the screens of the application-A 101, the application-B 102, or the application-C 103.

The support library 304 is a library for allowing the application-A 101, the application-B 102, or the application-C 103 to use various functions of the image forming apparatus 100.

FIG. 4A is a diagram illustrating files which constitute each of the application-A 101, the application-B 102, and the application-C 103 of the present exemplary embodiment.

Basically, each of the application-A 101, the application-B 102, and the application-C 103 includes at least three files, i.e., an application execution code file 401, an application fixed data file 402, and an application resource declaration file 403.

The application execution code file 401 is a file that includes an execution code of the application-A 101, the application-B 102, or the application-C 103.

The application fixed data file 402 is a file that stores fixed data such as a constant number or a character string retained by the application-A 101, the application-B 102, or the application-C 103.

The application resource declaration file 403 is a file for making a declaration of information about the application-A 101, the application-B 102, or the application-C 103 and the resources used thereby.

FIG. 4B is a diagram illustrating an internal configuration of the application resource declaration file 403. The application resource declaration file 403 includes information about the application-A 101, the application-B 102, or the application-C 103, such as an application ID, an application name, and resources used thereby. FIG. 4B is a diagram illustrating an example of an application for displaying a preview of an image included in the image forming apparatus 100. An ID “apli-imag-view” unique to the application is described in ApplicationID 411, and an application name “PreviewApp” is described in ApplicationName 412.

Further, upper limit values of the respective resources used by the application are described in ApplicationResourece 413.

In the example in FIG. 4B, upper limit values of a storage, a memory, a thread, a file descriptor, and a socket used by the application are described in a byte unit or a numerical value.

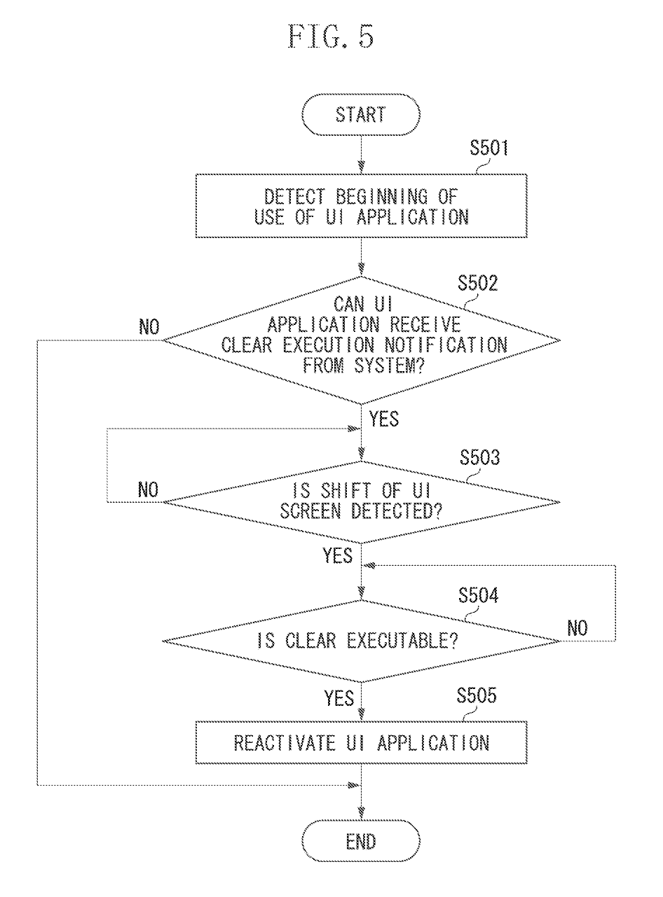

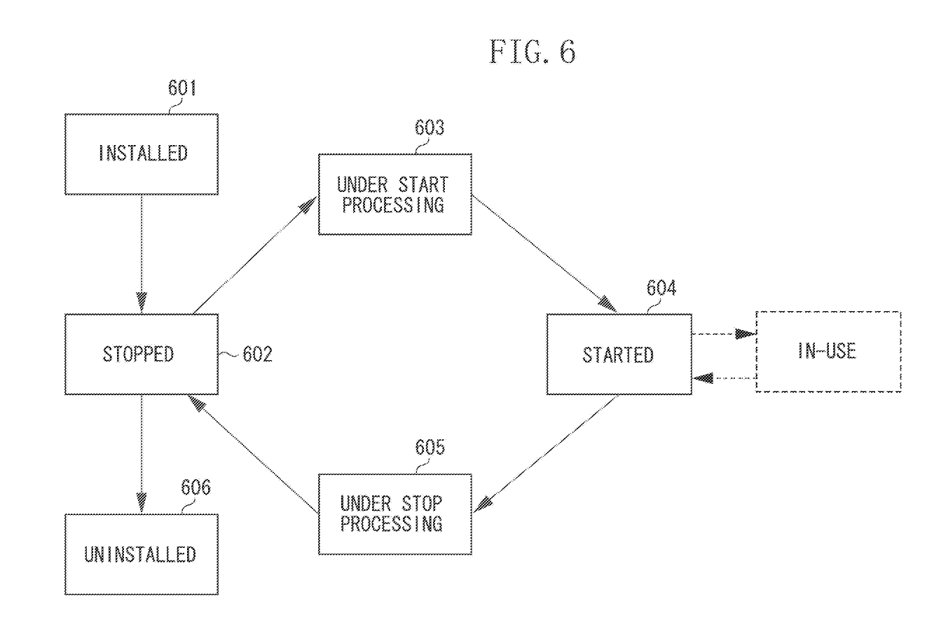

A first exemplary embodiment will be described. FIG. 5 is a flowchart illustrating processing of the application management framework 302. The CPU included in the core unit 200 executes a program to realize the application management framework 302.

First, in step S501, the UI control module 303 detects that an icon of the UI application displayed on the UI panel display unit 201 is pressed, and the application management framework 302 executes activation of the UI application having a UI screen.

Then, in step S502, the CPU determines whether the UI application is able to receive a clear execution notification from the application management framework 302. Herein, when the UI application capable of receiving the clear execution notification receives the clear execution notification, processing for returning the UI to an initial setting is executed by the application management framework 302. For example, in a case where a main unit of the system has not been used for a certain period and entered a sleep mode, the application management framework 302 executes processing for returning setting content of a color/monochrome print setting or a two-sided print setting for a copy function to a default setting. The above processing is executed by making the clear execution notification as a trigger.

As to whether the UI application is able to receive the above-described clear execution notification can be determined based on whether the UI application is registered in an area managed by the application management framework 302 as a listener of a clear execution notification event transmitted from the application management framework 302.

If the UI application is registered as a listener of the clear execution notification event, the CPU determines that the CPU can return the UI screen to a default screen without storing the UI screen. In other words, the CPU determines that there is no effect on the UI application even if the application management framework 302 executes initialization of the UI application.

If the CPU determines that the UI application is able to receive the clear execution notification from the application management framework 302 (YES in step S502), the processing proceeds to step S503. If the CPU determines that the UI application cannot receive the clear execution notification (NO in step S502), the CPU ends the flowchart without executing processing on the UI application.

In step S503, if the UI control module 303 detects a shift of the UI screen on the UI panel display unit 201 caused by end of use of the UI application (e.g., a screen of the UI application is shifted to an initial screen) (YES in step S503), the processing proceeds to step S504.

In step S504, the CPU determines whether the UI application is in a clear executable state in which the UI can be returned to an initial setting.

Generally, in a system in which a plurality of applications is operated, an application is provided with a function for prohibiting a state from being cleared or operation from being stopped when processing such as job processing which cannot be stopped halfway is being executed. Herein, if the processing cannot be stopped halfway, the UI application makes a declaration of rejecting the clear execution.

Therefore, in step S504, the CPU determines whether the above-described declaration of rejecting the clear execution is made by the UI application. If the declaration of rejecting the clear execution is not made by the UI application (YES in step S504), the processing proceeds to step S505. On the other hand, if the declaration of rejecting the clear execution is made by the UI application (NO in step S504), the CPU waits until the declaration is cancelled, and the processing proceeds to step S505 when the declaration of rejecting the clear execution is cancelled.

In step S505, the application management framework 302 determines that use of the UI application is ended and executes reactivation processing of the UI application. Then, the processing of this flowchart is ended.

### <Reactivation Processing>

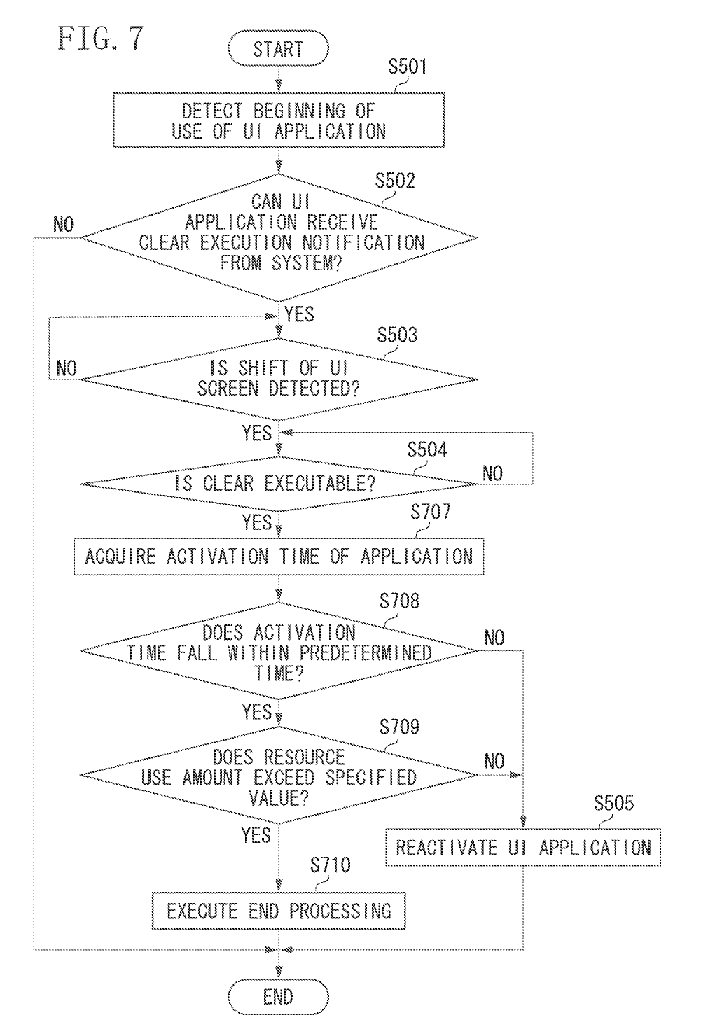

Subsequently, the reactivation processing of the UI application executed in step S505 will be described with reference to FIG. 6.

FIG. 6 is a conceptual diagram illustrating an example of an internal state and a life cycle of the application of the present system. It is assumed that the system conforms to a service platform known as “open service gateway initiative (OSGi)” based on Java, which is capable of remotely managing installation, activation, stop, or uninstallation of application software or a component.

In the system, when installation processing of the UI application is started, the application management framework 302 executed by the CPU refers to the application resource declaration file 403 of the UI application. Then, the application management framework 302 acquires information about an application name, an application ID, and use resources from the application resource declaration file 403.

If the UI application is installable, the application management framework 302 internally registers the information about the UI application and brings the UI application into an installed state 601. Then, the application management framework 302 executed by the CPU executes activation processing of the UI application automatically or based on the instruction from the user.

In the activation processing of the UI application, the CPU loads a class necessary for activating the UI application itself, so that the UI application is brought into a stopped state 602 where a dependence relationship is cancelled.

Thereafter, the application management framework 302 starts executing start processing to shift the UI application to a state under start processing 603. In the state under start processing 603, the UI application executes UI display registration processing of the UI application with respect to the UI control module 303. When the UI display registration processing is executed, the UI control module 303 displays an icon of the UI application on the UI panel display unit 201.

When the above processing is ended, the application management framework 302 brings the UI application into a started state 604.

The processing of the flowchart in FIG. 5 is started from a state where the UI of the UI application is displayed as a result of an icon of the UI application in a started state 604 being pressed at the UI panel display unit 201 and the application being activated thereby. Thereafter, the screen is shifted when use of the UI application is ended, and processing proceeds to reactivation processing.

Then, in the reactivation processing of the UI application in step S505 in FIG. 5, the application management framework 302 firstly starts stop processing of the UI application. When the stop processing is started, the application management framework 302 brings the UI application into a state under stop processing 605.

In the state under stop processing 605, the UI application executes UI display deletion processing with respect to the UI control module 303. When the UI display deletion processing is executed, the UI control module 303 deletes the icon of the UI application and cancels the registration with respect to the UI panel display unit 201.

When the UI display deletion processing is completed, the application management framework 302 shifts the UI application to a stopped state 602.

Then, the application management framework 302 shifts the UI application to the state under start processing 603 again, executes the UI display registration processing with respect to the UI panel display unit 201 again, and shifts the UI application to the started state 604.

Through the reactivation processing, the UI of the UI application returns to a non-displayed state once, and reference of the resources such as the UI object used until that moment is terminated, and thus it is possible to release the memory.

In the above-described reactivation processing, the deletion processing and the registration processing with respect to the UI panel display unit 201 are executed in the state under stop processing 605 and the state under start processing 603. However, processing similar to the above processing can be executed by notifying the UI control module 303 about reactivation while omitting the deletion processing and the registration processing with respect to the UI panel display unit 201.

In the first exemplary embodiment, resources used by the UI application is released by executing the reactivation processing. However, there is a case where an amount of resources retrieved by the reactivation processing is small. Further, depending on the condition of the resources in the image forming apparatus 100, there is a case where the resources have to be further retrieved because the amount of retrieved resources is not sufficient.

In a second exemplary embodiment, processing for further retrieving more resources will be described.

Processing executed by the application management framework 302 of the present exemplary embodiment will be described with reference to a flowchart in FIG. 7. In the flowchart in FIG. 7, the same reference numerals are applied to steps common to those described in FIG. 5, and description thereof is omitted.

The processing illustrated in this flowchart is realized by the CPU by executing the application management framework 302, which is a program according to an embodiment.

In this flowchart, similar to the first exemplary embodiment, in step S501, the UI control module 303 firstly detects activation of the UI application. Thereafter, the CPU executes processing in steps S502 to S503, so that the processing proceeds to step S504.

In step S504, if the application management framework 302 determines that the UI application is in a clear executable state (YES in step S504), the processing proceeds to step S707.

On the other hand, if the UI application is not in a clear executable state (NO in step S504), the CPU waits until clearance is executable. When the clearance is executable, the processing proceeds to step S707.

In step S707, activation time of the UI application is acquired. The activation time of the UI application is calculated from information about the application such as a number and a size of Java Archive (jar) files included in the UI application or a number of classes to be loaded.

In addition, the activation time of the UI application may be acquired from a log of the application management framework 302.

Then, in step S708, the CPU determines whether the activation time of the UI application falls within a predetermined time. The predetermined time is an assumed period of time the user can wait for the UI application to be activated, and an influence on the user is determined to be small if the UI application can be activated within that period. This predetermined time may be a time previously determined by the system, or may be set through a user input.

In step S708, if the CPU determines that the activation time of the UI application falls within the predetermined time (YES in step S708), the processing proceeds to step S709. If the CPU determines that the activation time of the UI application does not fall within the predetermined time (NO in step S708), the processing proceeds to step S505, and the application management framework 302 reactivates the UI application.

Next, in step S709, the application management framework 302 acquires a use amount of the resources within the image forming apparatus 100 from the application execution platform 301, and determines whether the use amount exceeds a specified value.

In step S709, if the application management framework 302 determines that the use amount of the resources within the image forming apparatus 100 exceeds the specified value (YES in step S709), the processing proceeds to step S710, and the application management framework 302 executes end processing of the UI application. If the application management framework 302 determines that the use amount of the resources does not exceed the specified value (NO in step S709), the processing proceeds to step S505. In step S505, the application management framework 302 executes reactivation processing of the UI application.

### <End Processing of UI Application>

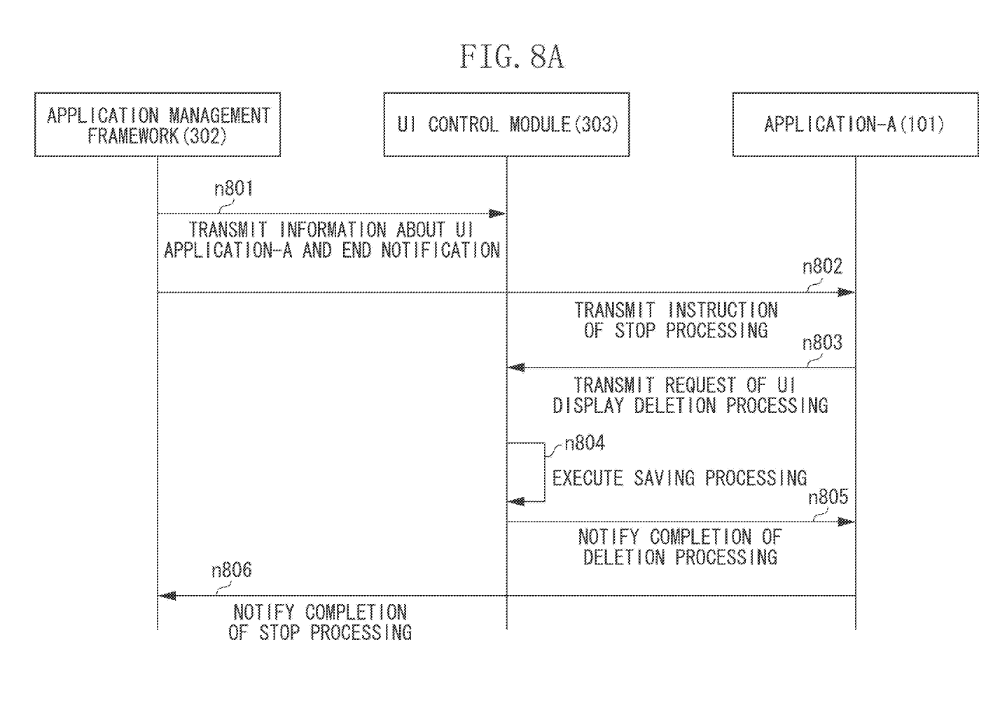

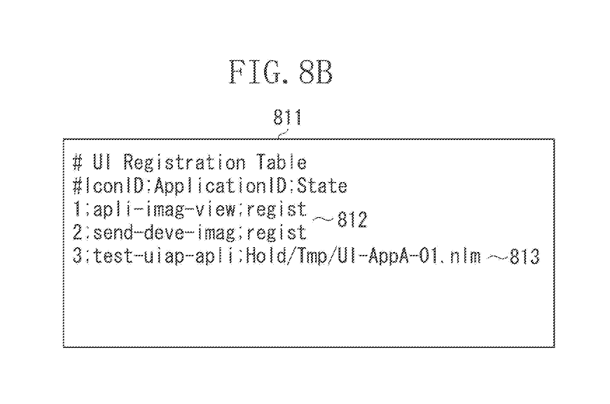

Subsequently, end processing of an application will be described with reference to FIGS. 6, 8A, and 8B.

In the end processing in step S710 of the second exemplary embodiment, end of the UI application is determined in the started state 604, so that the UI application shifts to the uninstalled state 606 via the state under stop processing 605 and the stopped state 602.

The stop processing that executed when end of the UI application is determined in the started state 604 will be described with reference to FIGS. 8A and 8B. FIG. 8A is a diagram schematically illustrating notifications transmitted between the application management framework 302, the UI control module 303, and the UI application-A 101.

First, when end processing of the UI application is started, in step n801, the application management framework 302 transmits information about the UI application-A 101 as a target of the end processing and a notification about ending of the UI application-A 101 to the UI control module 303.

Then, in step n802, the application management framework 302 instructs the UI application-A 101 as an end processing target to execute stop processing.

In step n802, the UI application-A 101 as an end processing target receives the instruction of the stop processing. In step n803, the UI application-A 101 transmits a request of UI display deletion processing to the UI control module 303.

The UI control module 303 receives the request of UI display deletion processing from the UI application-A 101 and updates the UI registration table 811 illustrated in FIG. 8B based on the information transmitted from the application management framework 302. The UI display is deleted when the UI registration table 811 is updated.

In step n804, the UI control module 303 saves the installed package to another area.

The UI registration table 811 illustrated in FIG. 8B is managed by the UI control module 303. In the table, an icon ID of the application, an application ID, and a state of each application are associated with each other.

The UI registration table 811 is updated when the above-described UI display registration processing or the UI display deletion processing is executed. Herein, a state 812 where applications such as “apli-imag-view” and “send-deve-image” are registered is shown.

Then, in the saving processing in step n804, the UI control module 303 changes a state 813 of the information about the UI application-A 101 (test-uiap-apli) to “Hold” without deleting the information from the UI registration table 811. Then, in step n805, the UI control module 303 returns a notification of completion of deletion processing to the UI application-A 101.

In step n806, the UI application-A 101 notifies the application management framework 302 about completion of the stop processing.

Then, the application management framework 302 shifts the UI application-A 101 to the stopped state 602, and executes uninstall processing of the UI application-A 101 to shift the UI application-A 101 to the uninstalled state 606.

At this time, although the internal state of the application management framework 302 is brought into a state where the UI application-A 101 is not installed, the UI is brought into a state (“Hold” state) where the icon is registered thereon.

Next, processing to be executed when an icon of the UI application-A 101 displayed on the UI panel display unit 201 is pressed in the above state will be described.

When the UI control module 303 detects a press of the icon on the UI panel display unit 201, the UI control module 303 acquires an ID of the pressed icon and refers to the UI registration table 811.

If an ID of the icon is already registered in the UI registration table 811, the UI control module 303 notifies the application management framework 302 of execution of the corresponding application and loads the UI of that application.

If the state 813 of the ID of the icon is registered as “Hold” in the UI registration table 811, the UI control module 303 notifies the application management framework 302 about a path “/Tmp/UI-App/-01.nlm” of a package of the saved application. Then, the application management framework 302 starts install processing of the corresponding UI application.

Therefore, the application management framework 302 shifts the UI application-A 101 to the started state 604 via the installed state 601, the stopped state 602, and the state under start processing 603, and loads the UI of the UI application-A 101.

In addition, because the UI display registration processing with respect to the UI control module 303 has already been executed by the UI application-A 101 in the state under start processing 603, only the content of the state 813 described in the UI registration table 811 is updated.

As described above, by executing the end processing instead of the reactivation processing, the UI application determined to be ended is uninstalled, so that the resources to be used for staring the UI application can remain unconsumed.

Further, in the present exemplary embodiment, time taken for activation is restricted within the allowable time, and end processing is executed when it is determined that the resources of the image forming apparatus 100 is decreased. In this way, the usability can be prevented from being lowered considerably.

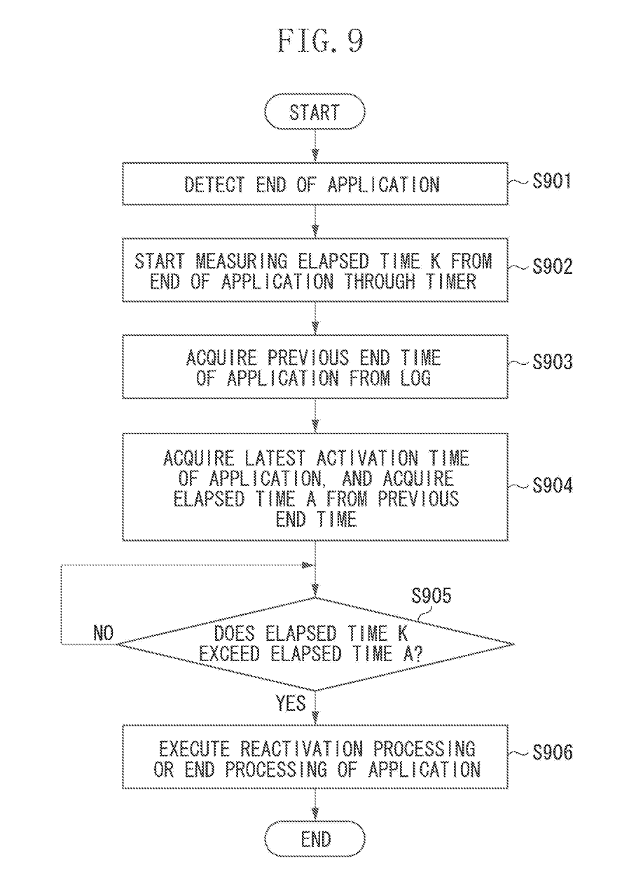

In a third exemplary embodiment, another processing of the application management framework 302 will be described with reference to FIG. 9.

In the example described in the first and the second exemplary embodiments, in a case where a declaration of rejecting clear execution is not made by the application when end of the application is detected, the resources consumed by the application is released by executing the reactivation processing or the end processing.

However, for example, if the end processing is executed, considerable amount of time will be required for activating the application. With respect to the application frequently activated by the user, time taken for activating the application is accumulated, and thus usability thereof may be lowered.

In a third exemplary embodiment described below, with respect to the frequently activated application, the end processing and reactivation processing will not be executed promptly, and the application is held in a started state for a predetermined time based on a usage interval of the application. Because the application can be promptly used when the user wishes to use the application again, lowering of the usability can be prevented. Then, in a case where a use interval of the application exceeds predetermined time, the resources held by the application can be released by executing the end processing or the reactivation processing.

The processing illustrated in this flowchart is realized by the CPU by executing the application management framework 302, which is a program according to an embodiment.

First, in step S901, the UI control module 303 executed by the CPU detects the end of use of the application.

In step S902, the CPU starts a timer to start measuring elapsed time K from use-end time point of the application.

In step S903, the application management framework 302 acquires the previous end time point of the application from a log.

Then, in step S904, the application management framework 302 acquires the latest activation time point of the application, and calculates and acquires elapsed time A from the previous end time point to the latest activation time point of the application. The elapsed time A represents the use interval of the application.

Then, the application management framework 302 compares the elapsed time K from detection of the end of the application and the elapsed time A. In step S905, if the elapsed time K exceeds the elapsed time A (YES in step S905), the processing proceeds to step S906. In step S906, the application management framework 302 executes the above-described reactivation processing of the application. At this time, as described in the second exemplary embodiment, depending on the activation time of the application and the state of the resources in the image forming apparatus 100, the application management framework 302 may determine to execute the end processing of the application instead of executing the reactivation processing.

Further, in the present exemplary embodiment, the elapsed time K from the end of the application is acquired by using a timer. However, the elapsed time K may be acquired by referring to the use-end time point of the application and the current time.

In the first and the second exemplary embodiments, when the end of the application is detected, reactivation processing or end processing is executed promptly. However, it will take considerable time to execute an application after executing the reactivation processing or the end processing. Therefore, the user has to wait if the application is used consecutively, and thus the usability will be deteriorated. However, by executing the processing described in the third exemplary embodiment, the usability can be prevented from being deteriorated.

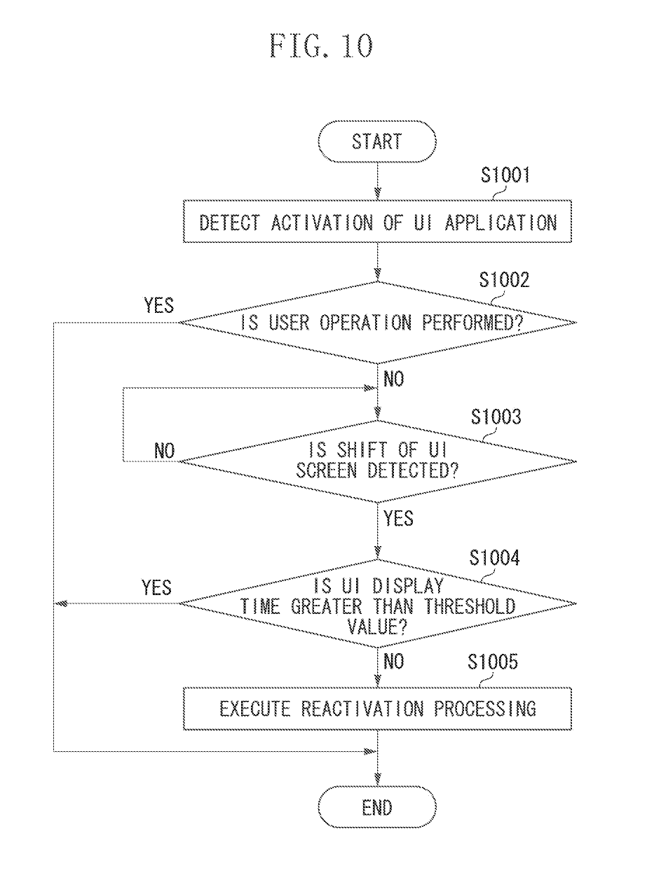

Processing executed by the application management framework 302 of a fourth exemplary embodiment will be described with reference to FIG. 10.

In the third exemplary embodiment, a started state of the UI application is retained for a predetermined time before the reactivation processing or the end processing is executed. However, for example, there is a case where the UI application is activated through an operation error in which the user activates the UI application unintentionally. In such a case, if a started state is retained for a predetermined time before the reactivation processing or the end processing is executed as described in the third exemplary embodiment, the resources may be unintentionally occupied by the unnecessary application. In the processing described in a fourth exemplary embodiment, the application activated by the erroneous operation can be promptly ended through detection of unintended user operation.

The processing illustrated in this flowchart is realized by the CPU by executing the application management framework 302, which is a program according to an embodiment.

In this flowchart, firstly, similar to the processing in step S501 in FIG. 5, in step S1001, the UI control module 303 detects activation of the UI application.

Then, in step S1002, the UI control module 303 determines whether user operation is performed with respect to the UI application. If user operation is performed (YES in step S1002), the flowchart is ended without executing any processing.

On the other hand, if user operation is not performed (NO in step S1002), the processing proceeds to step S1003. In step S1003, the CPU stands ready until a shift of the screen is detected. If a shift of the screen is detected (YES in step S1003), the processing proceeds to step S1004.

In step S1004, the UI control module 303 acquires UI display time of the UI application, and determines whether the UI display time exceeds a specified time (threshold value). If the UI display time of the UI application is the specified time or more (YES in step S1004), the processing is ended.

On the other hand, if the UI display time of the UI application is less than the specified time (NO in step S1004), the CPU determines the activation of the UI application as unnecessarily activation caused by an operation error of the user, so that the processing proceeds to step S1005.

In step S1005, the application management framework 302 executes reactivation processing of the UI application and ends the processing of this flowchart. In addition, the end processing of the UI application may be executed as described in the second exemplary embodiment instead of executing the reactivation processing.

As described above, according to the present exemplary embodiment, it is possible to prevent consumption of the resources caused by continuous activation of the UI application that is not necessary for the user.

Through the above-described exemplary embodiment, it is possible to manage the application to reduce the consumption of the internal resources of the information processing apparatus without deleting the application.

Further, the resources can be retrieved by making the resources continuously held by the application as a releasing target without deteriorating the usability of the information processing apparatus.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-058461, filed Mar. 24, 2017, which is hereby incorporated by reference herein in its entirety.

What is claimed is:

1. An information processing apparatus which manages a plurality of operating applications, the information processing apparatus comprising:
a first determination unit configured to determine whether the application has made a declaration of rejecting clear execution in a case where use of the application is ended,
wherein, in a case where the first determination unit determines that the application has not made the declaration of rejecting clear execution, the information processing apparatus executes reactivation processing of the application.

2. The information processing apparatus according to claim 1 further comprising a second determination unit configured to determine whether the application is able to receive a clear execution notification,
wherein, in a case where the second determination unit determines that the application cannot receive the clear execution notification, the information processing apparatus does not execute reactivation processing.

3. The information processing apparatus according to claim 1, wherein end of use of the application is detected through a shift of a user interface (UI) displayed on a display unit.

4. The information processing apparatus according to claim 1 further comprising:
a first acquisition unit configured to acquire activation time required for the application when the first determination unit determines that the application has not made the declaration of rejecting clear execution; and
a third determination unit configured to determine whether the acquired activation time of the application exceeds a predetermined time, wherein, in a case where the third determination unit determines that the activation time of the application does not exceed the predetermined time, the information processing apparatus executes end processing of the application.

5. The information processing apparatus according to claim 4, wherein the first acquisition unit calculates the activation time from information about the application which includes a number and a size of files included in the application and a number of classes to be loaded.

6. The information processing apparatus according to claim 4 further comprising a fourth determination unit configured to acquire a use amount of resources of the information processing apparatus to determine whether the use amount of the resources exceeds a specified value,
wherein, in a case where the fourth determination unit determines that the use amount of the resources of the information processing apparatus exceeds the specified value, the information processing apparatus executes end processing of the application.

7. The information processing apparatus according to claim 1 further comprising:
a timing unit configured to measure elapsed time when end of use of the application is detected;
a second acquisition unit configured to acquire a use interval of the application; and
a comparison unit configured to compare the use interval and the elapsed time of the application, wherein, in a case where the comparison unit determines that the elapsed time is greater than the use interval, the information processing apparatus executes reactivation processing of the application.

8. The information processing apparatus according to claim 7, wherein the use interval is acquired from previous use end time point and latest activation time point of the application.

9. The information processing apparatus according to claim 7, wherein the use interval is acquired from a log of activation and end of the application.

10. The information processing apparatus according to claim 1 further comprising a fifth determination unit configured to determine whether display time of a UI of the application is less than a threshold value,
wherein, in a case where the fifth determination unit determines that the display time of the UI is less than the threshold value, the information processing apparatus executes reactivation processing of the application.

11. The information processing apparatus according to claim 1 further comprising a fifth determination unit configured to determine whether display time of a UI of the application is less than a threshold value,
wherein, in a case where the fifth determination unit determines that the display time of the UI is less than the threshold value, the information processing apparatus executes end processing of the application.

12. A control method for an information processing apparatus which manages a plurality of operating applications, the control method comprising:
determining, in first determination, whether the application has made a declaration of rejecting clear execution in a case where a screen of the application is shifted,
wherein, in a case where it is determined in the first determination that the application has not made the declaration of rejecting clear execution, the information processing apparatus executes reactivation processing of the application.

13. The control method for the information processing apparatus according to claim 12 further comprising determining, in second determination, whether the application is able to receive the clear execution notification,
wherein, in a case where it is determined in the second determination that the application cannot receive the clear execution notification, the information processing apparatus does not execute reactivation processing.

14. The control method for the information processing apparatus according to claim 12, wherein end of use of the application is detected through a shift of a UI displayed on a display unit.

15. The control method for the information processing apparatus according to claim 12 further comprising:
acquiring activation time required for the application when it is determined that the application has not made the declaration of rejecting clear execution; and
determining, in third determination, whether the acquired activation time of the application exceeds a predetermined time,
wherein, in a case where it is determined in the third determination that the activation time of the application does not exceed the predetermined time, the information processing apparatus executes end processing of the application.

16. The control method for the information processing apparatus according to claim 15, wherein, in the acquisition, the activation time is calculated from information about the application which includes a number and a size of files included in the application and a number of classes to be loaded.

17. The control method for the information processing apparatus according to claim 15 further comprising acquiring, in fourth determination, a use amount of resources of the information processing apparatus to determine whether the use amount of the resources exceeds a specified value,
wherein, in a case where it is determined in the fourth determination that the use amount of the resources of the information processing apparatus exceeds the specified value, the information processing apparatus executes end processing of the application.

18. The control method for the information processing apparatus according to claim 12 further comprising:
measuring elapsed time when end of use of the application is detected;
acquiring a use interval of the application; and
comparing the use interval and the elapsed time of the application,
wherein, in a case where it is judged in the comparison that the elapsed time is greater than the use interval, the information processing apparatus executes reactivation processing of the application.

19. The control method for the information processing apparatus according to claim 18, wherein the use interval is acquired from previous use end time point and latest activation time point of the application.

20. The control method for the information processing apparatus according to claim 18, wherein the use interval is acquired from a log of activation and end of the application.
